(19) United States
(12) Patent Application Publication
(10) Pub. No.: US 2015/0058216 A1
(43) Pub. Date: Feb. 26, 2015

(54) ATM Enabling Interface with Mobile Technology

(71) Applicant: Sergio Luciani, Sarasota, FL (US)

(72) Inventor: Sergio Luciani, Sarasota, FL (US)

(21) Appl. No.: 14/464,998

(22) Filed: Aug. 21, 2014

Related U.S. Application Data
(60) Provisional application No. 61/959,333, filed on Aug. 21, 2013.

(51) Int. Cl. G06Q 20/10; G06Q 20/32

(52) U.S. Cl. CPC G06Q 20/1085; G06Q 40/02; G06Q 20/3274
USPC 705/43

(57) ABSTRACT

A user having a mobile device with optical recognition capabilities and a mobile payment software solution is able to scan a matrix QR code that, upon being scanned by the user's mobile device, links the user's mobile payment software to an ATM back-end administrative software allowing the user to complete banking transactions on the mobile device as if a traditional magnetic card has been swiped in the ATM. The user can also transfer funds to other mobile payment application users. The mobile software solution and ATM back-end generate unique identifiers and passwords that are compared by the software, confirming the identity of the user and providing a secure transaction environment.

### BACKGROUND OF THE INVENTION

### Current State of the Art

Today, almost all merchants, whether brick and mortar or e-commerce (online-based) businesses, accept electronic payments (e.g., credit cards, debit cards, gift cards, in addition to private payment solutions such as PayPal® and Google Wallet®) as tender for transactions. Electronic payments are also accepted by increasing numbers of vending machines, kiosks, automated tellers or other systems without a human needed to conduct the transaction or process an electronic payment as tender for the transaction. Banks have developed a network of Automated Teller Machine units commonly referred to as “ATMs”. The functionality of these machines have increased to the point that the ATMs are now able to process deposits of checks and cash in addition to allowing for withdrawal of cash from a customer's account. While ATMs provide a convenient alternative to traditional human bank tellers, they lack the ability to function directly as means of enabling the transfer of funds from A to A, B to B and all permutations thereof (A to B, B to A). The issue is further complicated and currently unavailable for international funds transfers. Currently, ATMs are limited in functionality primarily to deposit funds from an individual present on-site in the form of cash or check, or withdraw funds from accounts held in a banking institution which provided the individual with a magnetic card and access to their account via confirmation of the customer's secret pin code.

The internet created new opportunities to undertake financial transactions via the use of a computer. Most banks have developed electronic (“e-banking”) solutions including mobile banking solutions utilizing customer's mobile devices (e.g. smart phone, tablet, laptop computer). In addition to traditional financial and/or banking institutions, a set of new participants has emerged as a result of this enabling technology. Paypal® represents the most relevant player in this sector, bypassing the credit card industry and to some extent the traditional financial and banking institution system.

The emergence of mobile commerce enabled through the use of smart phones has brought a new dimension to financial transactions with the adoption of mobile payment platforms where consumers make use of their mobile devices and connections to a clearing environment to pay for a product or service using their smart phone or tablet and their credit cards. While this new functionality is expected to eventually take a large if not dominant share of the commerce undertaken with credit/debit card transactions, Mobile Payment Platforms and relative Mobile Payment Applications are not common outside the banking industry when they relate to the process of making money transfers from and among consumers and businesses. The problem is especially acute amongst individuals who do not have a bank account. While there is a widespread evolution of the “Prepaid Branded” card (e.g. MasterCard®, Visa®), which allow a non-banking customer to take advantage of the benefits of such financial instruments, these cards require replenishment of funds at specific points, incur high fees, and do not allow for fast and effective transfer of funds between individuals (or between businesses or between an individual and a business etc.).

The proposed architecture of the present invention allows a Mobile Payment System (“MPS”) to enable the users of their Application (and their Virtual Wallet) to replenish the card at any ATM belonging to one or more specific “Banks” where the Mobile Payment System had accounts set up, without incurring in the high fees normally associated with prepaid or with “non-customers” of the bank. It would allow users of a Mobile Payment Application to withdraw sums available in their balances from said ATMs without incurring high fees traditionally associated with non-customers, and to transfer balances from in their account to other users of the Mobile Payment Application of the subscribing MPS.

### SUMMARY OF THE INVENTION

The proposed architecture of the present invention allows a MPS to enable the users of their Application (and their Virtual Wallet) to replenish the card at any ATM belonging to one or more banks where the MPS has accounts set up, without incurring in the high fees normally associated with prepaid or with non-customers of the bank. It would allow users of a Mobile Payment Application to withdraw sums available in their balances from said ATMs without incurring high fees traditionally associated with non-customers, and to transfer balances from in their account to other users of the Mobile Payment Application of the subscribing MPS.

Security for such transactions is accomplished at the time the mobile device user scans the QR Code with the bank ATM ID. Upon scanning a QR Code recognized by the MPS as an ATM and requesting to initiate a transaction, the MPS generates and sends a passcode to the ATM/Bank back-end where it is confirmed by the bank software. The ATM/Bank back-end could likewise be enabled to generate unique identifiers to send to the MPS. This passcode is a unique identifier that allows the mobile application user to identify as the rightful party to execute the transaction, providing a secure environment to conduct the transaction.

Alternatively, the MPS may identify the specific User and ATM by predefining the specific terms of the available transactions (i.e. Amount to be deposited, withdrawn, or transferred). The MPS can cause the activation of a specific account at the ATM and either generate a dynamic password to be displayed on the Mobile Application which must be input in the ATM to complete the transaction or have a sufficient number of accounts with different passwords and create a policy of blocking the user if attempts are made to input the wrong password more than a predetermined number of times. The amount to be transacted and the password provide two layers of security for the transaction.

### BRIEF DESCRIPTION OF THE DRAWINGS

FIG. 1. shows a flow chart outlining the data flow and process of the preferred embodiment of the invention, where the user scans a QR code located at the ATM where the MPS has an account. User chooses transaction type and transaction amount. The ATM is activated. The information provided by the User is transmitted over the internet to the MPS server which generates a passcode which the User inputs into the ATM. The ATM administrative back-end program executes the transaction.

FIG. 2. shows a flow chart of the preferred embodiment of the invention whereby a money transfer is executed between two or more users of a mobile payment application.

### DESCRIPTION OF THE PREFERRED EMBODIMENT OF THE INVENTION

To achieve the foregoing utility in accordance with the purpose of the invention, preferred embodiments are described as follows.

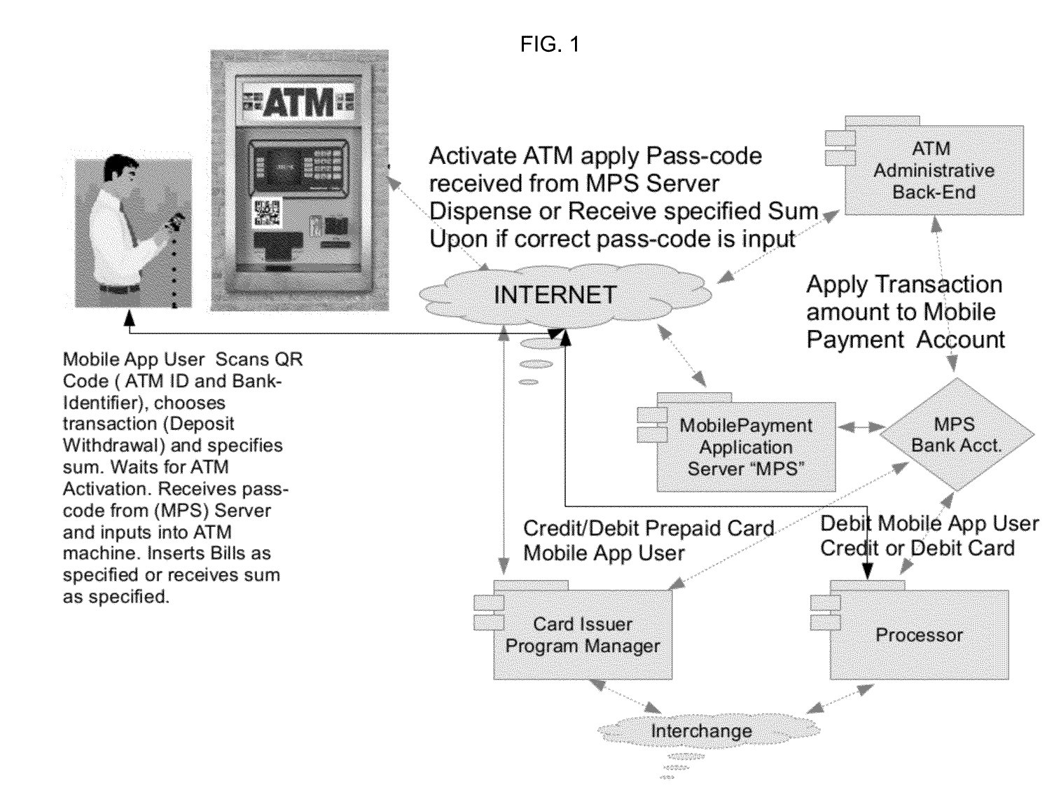

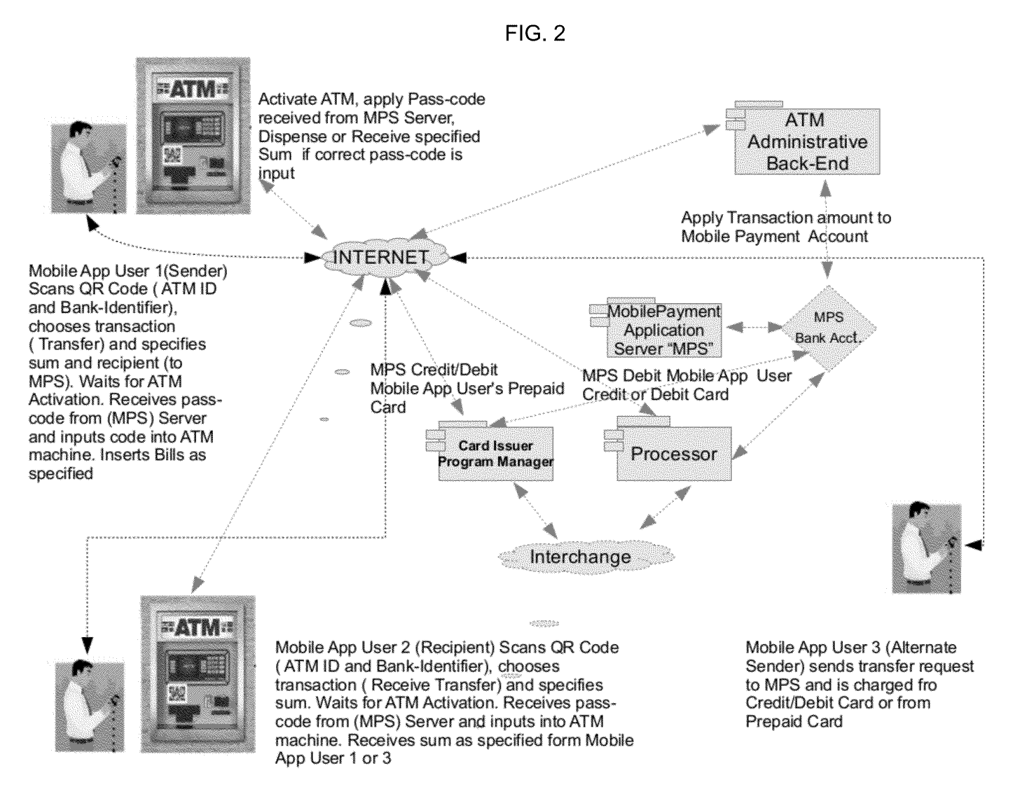

As shown in FIG. 1, a user having a mobile device with a mobile payment platform application installed thereon uses a standard ATM in a commonly used fashion to either deposit or withdraw funds which are credited to or debited from the user's account. The account can consist of a prepaid card (administered by a Prepaid Card Program Manager which is integrated with the MPS) or debited from the user's resident credit debit cards contained in the user's virtual wallet. Crediting while possible could be also accomplished with an ACH if the MPS had routing instructions for the App user's bank. As shown in FIG. 2, the user may transfer money between account or with another user of the MPS at the ATM or at the user's phone. The recipient receives monies from either channel. At the ATM, the user that does not have sufficient balance can deposit cash directly into the recipient's account.

I claim:

1. A method to conduct financial transactions at an Automatic Teller Machine (“ATM”) by Users in possession of mobile devices with a mobile payment application provided by a Mobile Payment Service (“MPS”) installed thereon, said Users not required to be a customer of a financial institution that provides ATM services and not required to be a customer entitled to banking services from any other financial institution in the ATM network, whereby:
a) said ATM having a static matrix/QR code label affixed to it or displayed on the ATM's in a place visible to said User;
I) said static matrix/QR codes linking to the MPS, identifying the particular Bank where the MPS has its account and the specific ATM ID (the “QR code data”);
b) said mobile devices having standard internet capabilities via Wi-Fi or other means known in the art, optical scanning recognition, and having a Mobile Payment Application resident on the device published by a Mobile Payment Service (“MPS”);
c) User scans said matrix/QR Code with user's mobile device which transmits the QR code data to MPS;
d) MPS receives notice of scan and receives QR code data and verifies the user account;
e) MPS prompts the Mobile Payment Application user to define the scope of the transaction to be conducted;
f) User selects banking transaction type comprising common ATM transactions including but not limited to account balance check, withdraw, deposit, and transfer between accounts;
g) MPS contacts the ATM back-end and requests activation of ATM and generates a password for the User while the ATM activates;
h) User obtains password from MPS and inputs into ATM via the mobile payment application or at the ATM; and
i) User conducts banking transaction and receives acknowledgment from ATM and MPS of complete transaction.

2. The method of claim 1 whereby:
a) said transaction type is a transfer between two users (User 1 and User 2);
b) said users having mobile devices with the same mobile payment application or MPS;
c) Upon scanning the QR Code, said MPS prompts User to define the recipient and amount to be transferred;
d) User 1 inputs the recipient and amount data through their Mobile Payment Application;
e) MPS requests definition of transfer as debit from User 1's existing financial instruments resident in the user's mobile payment application, or as a cash transaction;
User defines transaction as a cash transaction;
f) MPS contacts the ATM back-end and requests activation of ATM and generates a password for the User 1 while the ATM activates;
g) User 1 inputs password via mobile application or ATM and deposits sum to be transferred to User 2;
h) User 1 receives acknowledgment of successful transaction via ATM display and on mobile payment application; and
i) MPS contacts User 2, displaying on User 2's mobile device a notice of completion of the transaction and can also display customary accompanying information regarding the account, which may comprise of the deposited amount, fund availability information, and total balance available.

3. The method of claim 1, whereby:
a) User scans QR code located on ATM at a bank for which MPS is an account holder and the User is not an account holder;
b) MPS is notified that the user has scanned the QR code and identifies the User, Bank ID, ATM ID;
c) MPS generates a unique password and provides ATM administrative back-end and the user with the password;
d) ATM activates and requests the password to be entered by the User;
e) User obtains password from MPS and inputs password via mobile application or ATM;
f) User obtains amount and issuer of credit from MPS and may be prompted to enter amount into ATM;
g) ATM dispenses money to User; and
h) User is not charged customary fees for withdraw by a non-account holder of the bank.

4. The method of claim 1, 2, or 3, whereby:
a) MPS having predetermined parameters regarding the transaction (i.e. maximum amount allowed to be transfer between accounts, maximum amount allowed to be withdrawn);
b) Upon the User scanning the QR code, the MPS identifies the specific user and ATM;
c) MPS either generates a dynamic password to be displayed via the mobile application on the User's mobile device, said dynamic password is required to be input into the ATM to complete the desired transaction, or the MPS is linked to a series of accounts each with a unique password, and blocks the User if attempts are made to input the wrong password more than a predetermined number of times.
